(19) United States
(12) Patent Application Publication
(10) Pub. No.: US 2008/0069471 A1
(43) Pub. Date: Mar. 20, 2008

(54) Image de-blocking method

(75) Inventor: Fang-Chen Chang, Tainan County (TW)

Correspondence Address: RABIN & Berdo, PC, 1101 14TH STREET, NW, SUITE 500, WASHINGTON, DC, 20005, US

(73) Assignee: HIMAX TECHNOLOGIES LIMITED, Tainan County (TW)

(21) Appl. No.: 11/819,061

(22) Filed: Jun. 25, 2007

(30) Foreign Application Priority Data
Sep. 19, 2006 (TW) 95134623

(51) Int. Cl. G06K 9/40

(52) U.S. Cl. 382/268

(57) ABSTRACT

An image de-blocking method includes in a first stage, obtaining at least de-blocking pixel data of the first row of pixels and the second row of pixels according to at least the decompressed pixel data of a second row of pixels adjacent upward to a horizontal boundary, a first row of pixels adjacent upward to the second row of pixels and a third row of pixels adjacent downward to the horizontal boundary; and in a second stage, obtaining at least de-blocking pixel data corresponding to the third row of pixels and the fourth row of pixels according to at least the de-blocking pixel data of the second row of pixels adjacent upward to the horizontal boundary and the decompressed pixel data of the third row of pixels adjacent downward to the horizontal boundary and a fourth row of pixels adjacent downward to the third row of pixels.

This application claims the benefit of Taiwan application Serial No. 95134623, filed Sep. 19, 2006, the subject matter of which is incorporated herein by reference.

### BACKGROUND OF THE INVENTION

1. Field of the Invention

The invention relates in general to an image de-blocking method, and more particularly to an image de-blocking method which performs a vertical de-blocking operation in two stages in order to save memory space.

2. Description of the Related Art

Normally, image data is transmitted in a compressed form, such as a MPEG1, MPEG2 or JPEG form. The compressed image data will be decompressed to generate decompressed pixel data similar to the original image data for data processing and displaying in the next stage. During the block-based compression process, image data also distorts in a block form. Therefore, the decompressed pixel data obtained in the decompression operation usually has discontinuity situation at the horizontal and vertical boundaries of the blocks, which is called blocking effect. As shown in FIG. 1A, the decompressed pixel grey values of the pixels A, B and C have only slight difference and the grey values of the pixels D, E and F are very close as well. However, the decompressed pixel grey values of the pixels C and D adjacent to a block boundary may have obvious discontinuity, which results in reduction of image quality.

FIG. 1B is a schematic diagram of a conventional image de-blocking method. Referring to FIG. 1B, a display frame is normally divided into a number of pixel blocks B and each pixel block B includes a number of pixels P. The horizontal de-blocking method is used to perform a horizontal de-blocking operation on the decompressed pixel data V1˜V6 of at least three columns of pixels P adjacent left and right to the vertical boundary V at once to obtain smoother de-blocking pixel data. Besides, the vertical de-blocking method is used, for example, to perform a vertical de-blocking operation on the decompressed pixel data H1˜H6 of three row of pixels P adjacent upward and downward to a horizontal boundary H to obtain smoother de-blocking pixel data.

However, in terms of vertical de-blocking operation, owing that the display scans pixels row by row, in order to calculate the de-blocking pixel data of the pixel data H1˜H6, the display needs to store the decompressed pixel data of the six rows of pixels. As the number of the pixels increases, the display needs much more line buffers, which may be more than ten, for performing the vertical de-blocking operation, thereby increasing a manufacturing cost of the display.

### SUMMARY OF THE INVENTION

The invention is directed to an image de-blocking method. The vertical de-blocking operation is divided into two stages. In the first stage, a first vertical de-blocking operation is performed on the decompressed pixel data of the two rows of pixels adjacent upward to a block horizontal boundary and a row of pixels adjacent downward to the block horizontal boundary to obtain at least de-blocking pixel data of the two rows of pixels adjacent upward to the block horizontal boundary; in a second stage, a second vertical de-blocking operation is performed on the de-blocking pixel data of a row of pixels adjacent upward to the block horizontal boundary and the decompressed pixel data of the two rows of pixels adjacent downward to the block horizontal boundary to obtain at least de-blocking pixel data of the two rows of pixels adjacent downward to the block horizontal boundary. In this way, more memory space can be effectively saved and the manufacturing cost of the display can be reduced.

According to the present invention, an image de-blocking method is provided. The method is for removing a blocking effect of a display frame. The display frame comprises a plurality of pixels and has a plurality of blocks. the display frame is compressed to generate image compressed data corresponding to each block according to a plurality of original pixel data of the pixels of each block, and the image compressed data is decompressed to generate a plurality of decompressed pixel data for processing and displaying in a next stage corresponding to the pixels. The image de-blocking method comprises in a first stage, performing a first vertical de-blocking operation according to at least the decompressed pixel data of a second row of pixels adjacent upward to a horizontal boundary of the blocks, a first row of pixels adjacent upward to the second row of pixels and a third row of pixels adjacent downward to the horizontal boundary to obtain at least a plurality of de-blocking pixel data corresponding to the first row of pixels and the second row of pixels; and in a second stage, performing a second vertical de-blocking operation according to at least the de-blocking pixel data of the second row of pixels adjacent upward to the horizontal boundary and the decompressed pixel data of the third row of pixels adjacent downward to the horizontal boundary and a fourth row of pixels adjacent downward to the third row of pixels to obtain at least a plurality of de-blocking pixel data corresponding to the third row of pixels and the fourth row of pixels.

The invention will become apparent from the following detailed description of the preferred but non-limiting embodiments. The following description is made with reference to the accompanying drawings.

### BRIEF DESCRIPTION OF THE DRAWINGS

FIG. 1A is a schematic diagram of a conventional decompressed pixel data with a blocking effect.

FIG. 1B is a schematic diagram of a conventional image de-blocking method.

FIG. 2 is a flow chart of an image de-blocking method according to a preferred embodiment of the invention.

FIG. 3 is a schematic diagram of the two stages of vertical de-blocking operation according to the preferred embodiment of the invention.

FIG. 4 is a schematic diagram of calculation of de-blocking pixel data according to the decompressed pixel data in the two stages of vertical de-blocking operation of FIG. 3.

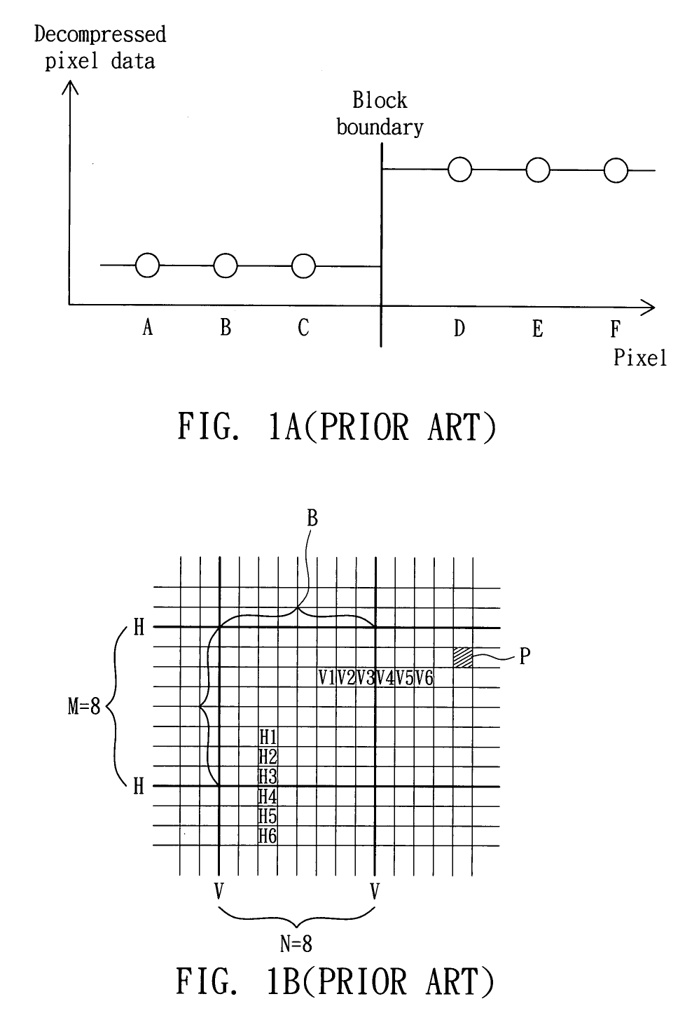

### DETAILED DESCRIPTION OF THE INVENTION

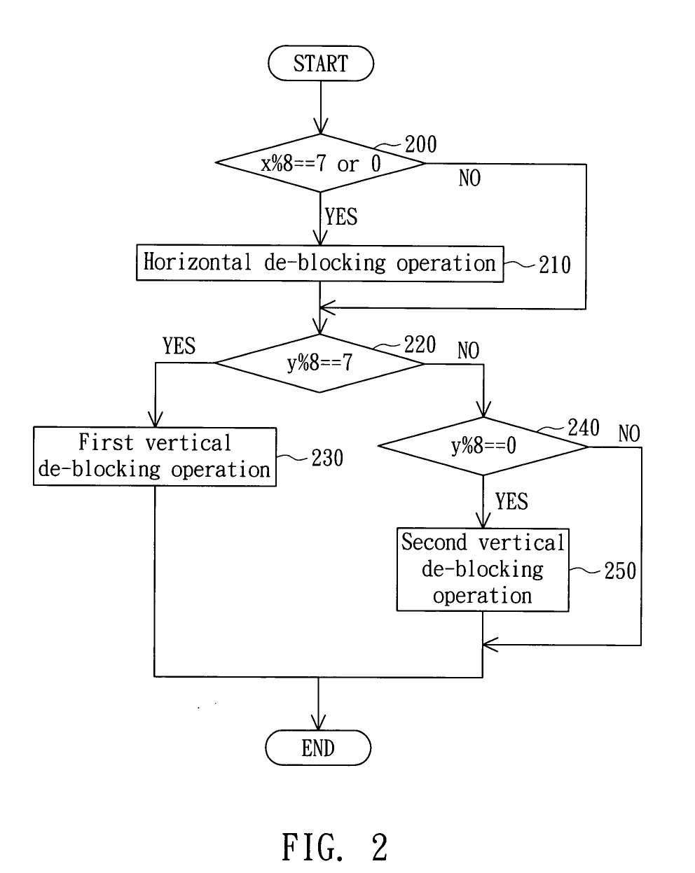

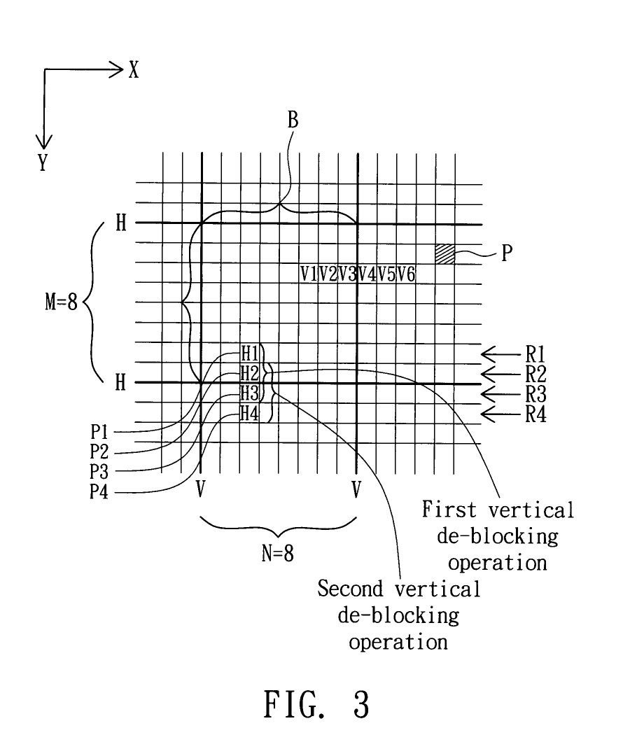

Referring to FIG. 2, a flow chart of an image de-blocking method according to a preferred embodiment of the invention is shown. The image de-blocking method is used to remove a blocking effect of a display frame. As shown in FIG. 3, the display frame includes a number of pixels P and is divided into a number of blocks B. Each block B includes M×N pixels, wherein M=N=8, for example. The display frame is compressed according to the original pixel data of the pixels P of each block B, such as in a MPEG1, MPEG2 and JPEG form to generate image compressed data corresponding to each block B. The image compressed data is decompressed to generate decompressed pixel data of each pixel P for processing and displaying in the next stage. Besides, the blocks form a number of vertical boundaries V and horizontal boundaries H and the horizontal boundary H is located between the (M×k) row of pixels and the (M×k+1) row of pixels, wherein k is a positive integer.

The image de-blocking method of the embodiment is as following:

First, in step 200, determine whether a horizontal position (the x-th column) of the pixel P to be processed is located on a vertical boundary V of the block B, that is, whether x % 8 is equal to 7 or 0, wherein x is a positive integer. If the pixel P is located on the vertical boundary V of the block B, that is, x % 8 is equal to 7 or 0, in the step 210, perform a horizontal de-blocking operation on the decompressed pixel data, such as V1˜V6 of a number of pixels P adjacent left and right to the pixel P to be processed at the same scan line, and then perform a determination operation in the step 220. If the pixel P is not located on the vertical boundary V of the block B, that is, x % 8 is not equal to 0 or 7, directly perform the step 220 to determine whether a vertical position (the y-th row) of the pixel P to be processed is located adjacent upward to a horizontal boundary H, that is, whether y % 8 is equal to 7. If the pixel P is located adjacent upward to the horizontal boundary H, that is, y % 8 is equal to 7, perform the step 230 of a first-stage vertical de-blocking operation as shown in FIG. 3. In the step 230, a first vertical de-blocking operation is performed according to the decompressed pixel data H2 and H1 of a second row R2 of pixels adjacent upward to the horizontal boundary H and a first row R1 of pixels adjacent upward to the second row R2 of pixels and the decompressed data H3 of a third row R3 of pixels adjacent downward to the horizontal boundary H to obtain de-blocking pixel data D1 and D2 respectively corresponding to the pixel P1 of the first row R1 of pixels and the pixel P2 of the second row R2 of pixels. Then, the process is ended. Therefore, at the same time when the image compressed data is decompressed to generate decompressed pixel data H1˜H3 of the first row R1 of pixels, the second row R2 of pixels and the third row R3 of pixels corresponding to the horizontal boundary H, the first vertical de-blocking operation can be performed.

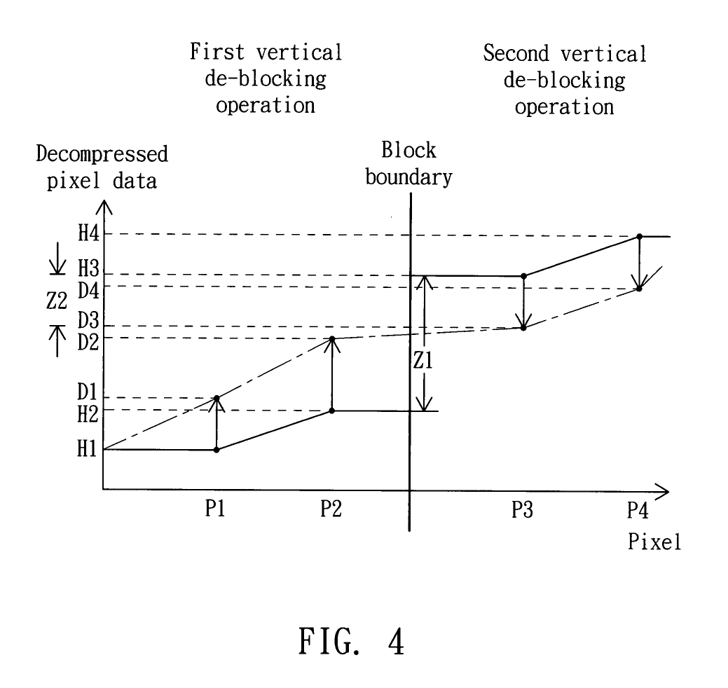

To describe in detailed, in the first vertical de-blocking operation, the de-blocking pixel data D2 of the pixel P2 of the second row R2 of pixels and the de-blocking pixel data D1 of the pixel P1 of the first row R1 of pixels are calculated according to a relative relationship among the decompressed pixel data H2 of the pixel P2 of the second row R2 of pixels, the decompressed pixel data H1 of the pixel P1 of the first row R1 of pixels and the decompressed pixel data H3 of the pixel P3 of the third row R3 of pixels. For example, as shown in FIG. 4, the values H1 and H2 are very close, while the decompressed data H2 and H3 of the pixels P2 and P3 on the block boundary have a large difference and the value H3 is larger than H2. The first vertical de-blocking operation is performed to calculate D1=H1+z¼ and D2=H2+z½ according to a difference (H3−H2)=z1.

Following that, if the pixel P is not located adjacent upward to the horizontal boundary H of the block B, that is, y % 8 is not equal to 7, perform the step 240 to determine whether the pixel P is located adjacent downward to the horizontal boundary H of the block B, that is, whether y % 8 is equal to 0. If the pixel P is located adjacent downward to the horizontal boundary H of the block B, that is, y % 8 is equal to 0, perform the step 250 of a second-stage vertical de-blocking operation as shown in FIG. 3. In the step 250, a second vertical de-blocking operation is performed according to the de-blocking pixel data D2 of the second row R2 of pixels adjacent upward to the horizontal boundary H and the decompressed pixel data H3 of the third row R3 of pixels adjacent downward to the horizontal boundary H and a fourth row R4 of pixels adjacent downward to the third row R3 of pixels to obtain de-blocking pixel data D3 and D4 respectively corresponding to the pixel P3 and the pixel P4 of the third row R3 and the fourth row R4 of pixels. Therefore, at the same time when the image compressed data is compressed to generate the decompressed pixel data H4 of the fourth row R4 of pixels corresponding to the horizontal boundary H, the second vertical de-blocking operation is performed.

To be described in details, the second vertical de-blocking operation is performed to calculate the de-blocking pixel data D3 of the pixel P3 of the third row R3 of pixels and the de-blocking pixel data D4 of the pixel P4 of the fourth row R4 of pixels according to a relative relationship among the decompressed pixel data H3 of the pixel P3 of the third row R3 of pixels, the de-blocking pixel data D2 of the pixel P2 of the second row R2 of pixels and the decompressed pixel data H4 of the pixel P4 of the fourth row R4 of pixels. For example, as shown in FIG. 4, the values H3 and H4 are very close, while the de-blocking pixel data D2 of the pixel P2 and the decompressed pixel data H3 of the pixel P3 on the block boundary have larger difference and discontinuity and the value H3 is larger than D2. The second vertical de-blocking operation is performed to calculate D3=H3-z 2/2 and D4=H4-z 2/4 according to a difference (H3−D2)=z2. As mentioned above, D2=H2+z½ and thus z2=z½, D3=H3-z¼ and D4=H4-z⅛.

Finally, if the pixel P is not located adjacent downward to the horizontal boundary H of the block B, that is, y % 8 is not equal to 0, end the process.

In the first stage of vertical de-blocking operation, the invention needs only three line buffers to store the decompressed pixel data H1˜H3 corresponding to the first row R1, the second row R2 and the third row R3 of pixels. In the second stage of vertical de-blocking operation, the invention stores the decompressed pixel data H4 corresponding to the fourth row R4 of pixels in the line buffer for storing the decompressed pixel data H1 of the first row R1 of pixels in the first stage. Similarly, the memory space needs only three line buffers. Therefore, the invention does not have to use at least 6 line buffers to store the decompressed pixel data of six rows of pixels as in the prior-art skill, which can effectively reduce memory space of the display.

As mentioned above, although the first vertical de-blocking operation is exemplified to calculate the de-blocking pixel data of the two rows of pixels adjacent upward to a horizontal boundary according to the decompressed pixel data of two rows of pixels adjacent upward to the horizontal boundary and a row of pixels adjacent downward to the horizontal boundary and the second vertical de-blocking operation is exemplified to calculate the de-blocking pixel data of the two rows of pixels adjacent downward to the horizontal boundary according to the decompressed pixel data of a row of pixels adjacent upward to the horizontal boundary and two rows of pixels adjacent downward to the horizontal boundary in the invention for illustration, the first-stage operation of the invention can also calculate the de-blocking pixel data of three or more than three rows of pixels adjacent upward to the horizontal boundary according to the decompressed pixel data of three or more than three rows of pixels adjacent upward to the horizontal boundary and one or more than one row of pixels adjacent downward to the horizontal boundary, and the second-stage operation calculates the de-blocking pixel data of the three or more than three rows of pixels adjacent downward to the horizontal boundary according to the de-blocking pixel data of the one or more than one row of pixels adjacent upward to the horizontal boundary and the decompressed pixel data of the three or more than three rows of pixels adjacent downward to the horizontal boundary. As long as in the first-stage operation, the de-blocking pixel data of the two rows of pixels adjacent upward to the horizontal boundary is calculated by using at least two rows of pixels adjacent upward to the horizontal boundary and a row of pixel adjacent downward to the horizontal boundary and in the second-stage operation, the de-blocking pixel data of the two rows of pixels adjacent downward to the horizontal boundary by using at least one row of pixels adjacent upward to the horizontal boundary and two rows of pixels adjacent downward to the horizontal boundary to achieve the purpose of saving display memory, all the alternatives will not depart from the scope of the invention.

The image de-blocking method disclosed by the above embodiment of the invention performs the vertical de-blocking operation in two stages. In the first stage, de-blocking pixel data of two rows of pixels adjacent upward to a horizontal boundary is obtained according to the decompressed pixel data of the two rows of pixels adjacent upward to the horizontal boundary and one row of pixels adjacent downward to the horizontal boundary. In the second stage, the de-blocking pixel data of two rows of pixels adjacent downward to the horizontal boundary is obtained according to the de-blocking pixel data of one row of pixels adjacent upward to the horizontal boundary and the decompressed pixel data of the two rows of pixels adjacent downward to the horizontal boundary. Therefore, not only the above blocking effect can be prevented, but also the manufacturing cost of the display can be effectively reduced for the display needs only the memory space capable of storing the decompressed pixel data of three rows of pixels in the vertical de-blocking operation.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image de-blocking method, for removing a blocking effect of a display frame, the display frame comprising a plurality of pixels and having a plurality of blocks of pixels, the display frame being compressed to generate image compressed data corresponding to each block according to a plurality of original pixel data of the pixels of each block, the image compressed data being decompressed to generate a plurality of decompressed pixel data for processing and displaying in a next stage corresponding to the pixels, the image de-blocking method comprising:
in a first stage, performing a first vertical de-blocking operation according to at least the decompressed pixel data of a second row of pixels adjacent upward to a horizontal boundary of the blocks, a first row of pixels adjacent upward to the second row of pixels and a third row of pixels adjacent downward to the horizontal boundary to obtain at least a plurality of de-blocking pixel data corresponding to the first row of pixels and the second row of pixels; and
in a second stage, performing a second vertical de-blocking operation according to at least the de-blocking pixel data of the second row of pixels adjacent upward to the horizontal boundary and the decompressed pixel data of the third row of pixels adjacent downward to the horizontal boundary and a fourth row of pixels adjacent downward to the third row of pixels to obtain at least a plurality of de-blocking pixel data corresponding to the third row of pixels and the fourth row of pixels.

2. The image de-blocking method according to claim 1, wherein each of the blocks comprises M×N pixels, and the horizontal boundaries are located between the (M×k) row of pixels and the (M×k+1) row of pixels, wherein M, N and k are positive integers.

3. The image de-blocking method according to claim 1, wherein the first vertical de-blocking operation is performed to adjust the decompressed pixel data of each pixel of the second row of pixels and the decompressed pixel data of the corresponding pixel of the first row of pixels according to a difference between the decompressed pixel data of the corresponding pixel of the second row of pixels and the decompressed pixel data of the corresponding pixel of the third row of pixels.

4. The image de-blocking method according to claim 1, wherein the second vertical de-blocking operation is performed to adjust the decompressed pixel data of each pixel of the third row of pixels and the decompressed pixel data of the corresponding pixel of the fourth row of pixels according to a difference between the de-blocking pixel data of the corresponding pixel of the second row of pixels and the decompressed pixel data of the corresponding pixel of the third row of pixels.

5. The image de-blocking method according to claim 1, wherein the step of performing the first vertical de-blocking operation further comprises storing the decompressed pixel data of the first row of pixels, the second row of pixels and the third row of pixels for the first vertical de-blocking operation by a memory and the step of performing the second vertical de-blocking operation further comprises storing the decompressed pixel data of the fourth row of pixels in the memory to substitute for the decompressed pixel data of the first row of pixels.

6. The image de-blocking method according to claim 1, further comprising performing a horizontal de-blocking operation according to a plurality of columns of pixels adjacent to a vertical boundary of the blocks.

7. The image de-blocking method according to claim 1, wherein the step of performing the first vertical de-blocking operation comprises performing the first vertical de-blocking operation at the same time when decompressing the image compressed data to generate the decompressed pixel data of the first row of pixels, the second row of pixels and the third row of pixels corresponding to the horizontal boundary.

8. The image de-blocking method according to claim 1, wherein the step of performing the second vertical de-blocking operation comprises performing the second vertical de-blocking operation at the same time when decompressing the image compressed data to generate the decompressed pixel data of the fourth row of pixels corresponding to the horizontal boundary.

9. The image de-blocking method according to claim 1, wherein the display frame is compressed in MPEG1, MPEG2 and JPEG format.
